(19) United States
(12) Patent Application Publication
(10) Pub. No.: US 2004/0080543 A1
(43) Pub. Date: Apr. 29, 2004

(54) Electronic device

(75) Inventors: Kazuya Sakurai, Kanagawa (JP); Takao Koishi, Kanagawa (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd., Osaka (JP)

(21) Appl. No.: 10/686,973

(22) Filed: Oct. 16, 2003

(30) Foreign Application Priority Data
Oct. 21, 2002 (JP) 2002-305900

(51) Int. Cl. G09G 5/00

(52) U.S. Cl. 345/810

(57) ABSTRACT

A plurality of menus formed in a hierarchical structure is displayed on a liquid-crystal display portion. The menus displayed on the liquid-crystal display portion are selected by direction buttons. The execution of the menu being displayed on the liquid-crystal display portion can be selected by an execution instructing button, and can be set in a direct execution menu by a setting button. The direct execution menu is assigned to a direct-execution instructing button. The execution can be selected directly by pressing the relevant direct-execution instructing button, i.e., without effecting the operation of searching the target menu by displaying lower-level menus consecutively starting with the highest-level menu. The electronic device is capable of directly executing a menu at an arbitrary level from among a plurality of menus formed in a hierarchical structure.

### BACKGROUND OF THE INVENTION

1. Field of the Invention

The present invention relates to an electronic device having the function of displaying in a hierarchical order a plurality of menus formed in a hierarchical structure, and more particularly to an electronic device which is capable of directly executing a menu at an arbitrary level.

2. Description of the Related Art

Conventionally, an electronic device such as a closed circuit television (CCTV) has a display portion for displaying functions in menus, and is capable of selecting a desired menu from among the displayed menus and of instructing to execute the desired menu. However, the number of menus to be displayed on the display portion has increased in conjunction with the diversification of functions provided in the electronic device, and the display, selection, and instruction of execution thereof have become difficult. Accordingly, in a case where the number of menus is too numerous with respect to the area of the display portion, a method has come to be adopted in which the menus are hierarchized and are displayed on the display portion in a hierarchical order.

JP-A-2000-10702 is known as a related art.

However, with the conventional method of displaying menus in the electronic device, menus at lower levels are consecutively displayed starting with an uppermost layer, and the execution of a target menu can be instructed for the first time when that target menu is displayed. Therefore, there has been a problem in that time and trouble are involved from the initial state of the menu display until the execution of the target menu is instructed.

### SUMMARY OF THE INVENTION

The object of the invention is to provide an electronic device which is capable of directly executing a menu at an arbitrary level from among a plurality of menus formed in a hierarchical structure.

The invention is to provide an electronic device has: display means for displaying in a hierarchical order a plurality of menus formed in a hierarchical structure; menu-display selecting means for selecting a menu to be displayed on said display means; execution instructing means for instructing to execute a menu being displayed on said display means; direct-execution-menu setting means for setting the menu being displayed on said display means as a direct execution menu; and direct-execution instructing means for instructing to execute the menu set as the direct execution menu.

Thus, the menu being displayed on the display means can be set on the direct execution menu by the direct-execution-menu setting means, and a menu at an arbitrary level can be directly executed from among the plurality of menus formed in the hierarchical structure. Therefore, it is possible to substantially reduce the time and trouble involved from the initial state of the menu is displayed until the target menu is instructed to execute.

In addition, the electronic device further has setting-change protecting means for regulating a change of a setting of the direct execution menu by a password. Accordingly, the arrangement is provided such that the setting of the direct execution menu cannot be changed arbitrarily by another person, thereby making it possible to protect the setting of the direct execution menu from being changed arbitrarily by another person.

### BRIEF DESCRIPTION OF THE DRAWINGS

FIG. 1 is a plan view illustrating an embodiment of an electronic device in accordance with the invention.

### DETAILED DESCRIPTION OF THE PREFERRED EMBODIMENTS

Hereafter, a detailed description will be given of an embodiment of an electronic device in accordance with the invention with reference to the drawing.

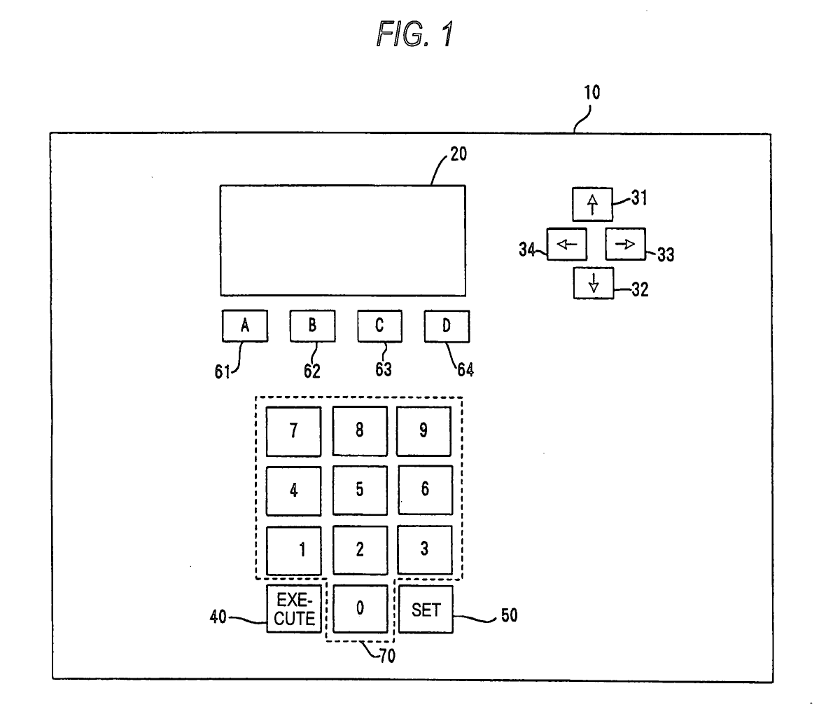

FIG. 1 is a plan view illustrating an embodiment of an electronic device in accordance with the invention. As shown in the drawing, an electronic device 10 such as a closed circuit television (CCTV) has a liquid-crystal display portion 20 corresponding to a display means in the claim; direction buttons 31 to 34 corresponding to a menu-display selecting means; an execution instructing button 40 corresponding to an execution instructing means; a setting button 50 corresponding to a direct-execution-menu setting means and a setting-change protecting means; direct-execution instructing buttons 61 to 64 corresponding to a direct-execution instructing means; and numeric buttons 70 corresponding to the setting-change protecting means for “0” to “9.”

Hereafter, a description will be given of the respective components of the electronic device in accordance with this embodiment. The liquid-crystal display portion 20 is a display means for displaying menus of functions provided in the electronic device 10, and displays in the hierarchical order a plurality of menus formed in a hierarchical structure. In addition, the direction buttons 31 to 34 are operating keys for selecting the menus to be displayed on the liquid-crystal display portion 20. If the direction buttons 31 to 34 are operated, the menus displayed on the liquid-crystal display portion 20 are selected in the hierarchical order (ascending order or descending order). Further, the execution instructing button 40 is an operating key for instructing the execution of the menu. If the execution instructing button 40 is pressed, the instruction of execution of the menu displayed on the liquid-crystal display portion 20 at that time is effected.

In addition, the setting button 50 is an operating key for setting the menu being displayed on the liquid-crystal display portion 20 on a direct execution menu. In addition, the direct-execution instructing buttons 61 to 64 are operating keys for instructing the execution of the menu set on the direct execution menu. In this embodiment, if one of the direct-execution instructing buttons 61 to 64 and the setting button 50 are pressed simultaneously, the menu being displayed on the liquid-crystal display portion 20 at that time is set on the direct execution menu. At the same time, that direct execution menu is assigned to the direct-execution instructing button which was pressed simultaneously with the setting button 50. Incidentally, arbitrary direct execution menus can be respectively assigned to the direct-execution instructing buttons 61 to 64.

In addition, the numeric buttons 70 are operating keys for inputting an arbitrary numeric value or symbol. In this embodiment, the arrangement provided is such that if the setting button 50 is pressed after a numeric value of a predetermined number of digits is inputted by the numeric buttons 70, that numeric value is set as a password (secret identification code). After setting the password, the setting of the direct execution menu cannot be changed unless a correct password is inputted.

Next, a description will be given of the operation of the electronic device 10 in accordance with this embodiment. If the electronic device 10 is started, highest-level menus are displayed on the liquid-crystal display portion 20. In the case where any one of the functions of the electronic device 10 is to be used, a user operates the direction buttons 31 to 34 to select the display on the liquid-crystal display portion 20 and display a target menu. Then, the user presses the execution instructing button 40 in that state. Consequently, the instruction of execution of the target menu is effected.

The operation provided so far is similar to that of a conventional electronic device. In the case where a particular menu is used frequently, if the execution instructing button 40 is pressed after displaying the relevant menu by operating the direction button 31 to 34 on each such occasion, much time and trouble are involved from the initial state of the menu is displayed until the menu is instructed to execute.

Accordingly, in the case where a particular menu is used frequently, in this embodiment that menu is set in the “direct execution menu” in advance. The setting of the direct execution menu is effected by simultaneously pressing any one of the direct-execution instructing buttons 61 to 64 and the setting button 50 in the state in which the target menu is displayed on the liquid-crystal display portion 20. Then, the direct execution menu thus set is assigned to the direct-execution instructing button 61, 62, 63, or 64 which was pressed simultaneously with the setting button 50.

As for the menu which has been set in the direct execution menu, its execution can be selected directly by pressing the direct-execution instructing button 61, 62, 63, or 64 to which that menu has been assigned, i.e., without undergoing the operation of searching that menu by operating the direction buttons 31 to 34. Accordingly, the time and trouble involved from the initial state of the menu display until the instruction of the target menu can be substantially reduced as compared with the conventional arrangement.

In addition, by setting the password in advance, it is possible to protect the setting of the direct execution menu from being changed arbitrarily by another person.

What is claimed is:

1. An electronic device comprising:
display means for displaying in a hierarchical order a plurality of menus formed in a hierarchical structure;
menu-display selecting means for selecting a menu to be displayed on said display means;
execution instructing means for instructing to execute a menu being displayed on said display means;
direct-execution-menu setting means for setting the menu being displayed on said display means as a direct execution menu; and
direct-execution instructing means for instructing to execute the menu set as the direct execution menu.

2. The electronic device according to claim 1, further comprising:
setting-change protecting means for regulating a change of a setting of the direct execution menu by a password.
